(19) United States
(12) Patent Application Publication
(10) Pub. No.: US 2016/0098573 A1
(43) Pub. Date: Apr. 7, 2016

(54) Securing a Distributed File System

(71) Applicant: Zettaset, Inc., Mountain View, CA (US)

(72) Inventor: Maksim Yankovskiy, Mountain View, CA (US)

(21) Appl. No.: 14/506,359

(22) Filed: Oct. 3, 2014

(51) Int. Cl. G06F 21/62; G06F 17/30

(52) U.S. Cl. CPC G06F 21/6218; G06F 17/30203; G06F 17/30592

(57) ABSTRACT

System and methods for a secured distributed file system (DFS) achieved by providing access control to the data stored in the DFS based on mapping of access privileges from a data warehouse to the DFS. A preferred embodiment of the invention uses a Hive data warehouse in concert with a Hadoop Distributed File System (HDFS). The invention provides an enhanced access control framework in HDFS. Since direct data access requests to files in HDFS corresponding to Hive tables, objects or other constructs can be unrestricted, present invention overcomes this problem by mapping the access privileges on Hive tables, objects and other constructs as defined in Hive metastore to file permissions on the corresponding files in HDFS. It then uses this mapping to provide access control for file(s) stored in HDFS.

### FIELD OF THE INVENTION

This invention relates generally to file system security and in particular to providing an enhanced access control framework for a distributed file system like Apache Hadoop Distributed File System (HDFS). The invention provides such an access control framework based on the access privileges of a data warehouse like Apache Hive data warehouse operating in concert with the distributed file system.

### BACKGROUND ART

Information security is an active field of academic and industrial pursuit. With the news of exploitation of software vulnerabilities by hackers and data breaches a commonplace occurrence, it is unsurprising that many academic and professional institutions are focusing their efforts to develop tools, practices and frameworks that aim to make Information Technology (IT) eco-systems more secure against exploitative attacks from domestic and global hackers and adversaries.

In as far as securing the contents residing on a file system, there are many ways of providing data security in the prior art. U.S. Pat. No. 8,429,192 to Burnett discloses a system, method and computer program for supporting a plurality of Access Control List types for a file system in an operating system in a data processing system. An Access Control List supporting system for managing access to a file system in a data processing system has at least one file system in an operating system of the data processing system, and an Access Control List management framework in the operating system and external to the at least one file system for managing access to the at least one file system. The Access Control List supporting system of the invention removes ACL management and access check-related functions from the at least one file system to an external Access Control List management framework, thus enabling an operating system to support a plurality of Access Control List types using the same Access Control List management framework and enabling new Access Control List types to be added to the operating system dynamically while the operating system is running.

U.S. patent application Ser. No. 13/868,961 to Tandon discloses a method and system for assessing the cumulative set of access entitlements to which an entity, of an information system, may be implicitly or explicitly authorized, by virtue of the universe of authorization intent specifications that exist across that information system, or a specified subset thereof, that specify access for that entity or for any entity collectives with which that entity may be directly or transitively affiliated. The effective system-level access granted to the user based upon operating system rules or according to access check methodologies is determined and mapped to administrative tasks to arrive at the cumulative set of access entitlements authorized for the user.

U.S. Pat. No. 5,941,947 to Brown discloses a system and methods for access rights of users of a computer network with respect to data entities specified by a relational database stored on one or more security servers. Application servers on the network that provide user access to the data entities generate queries to the relational database in order to obtain access rights lists of specific users. An access rights cache on each application server caches the access rights lists of the users that are connected to the respective application server, so that user access rights to specific data entities can be rapidly determined. Each user-specific access rights list includes a series of category identifiers plus a series of access rights values. The category identifiers specify categories of data entities to which the user has access, and the access rights values specify privilege levels of the users with respect to the corresponding data entity categories. The privilege levels are converted into specific access capabilities by application programs running on the application servers.

U.S. Pat. No. 6,625,603 to Garg discloses an object type specific access control to an object. In one embodiment, a computer system comprises an operating system operative to control an application and a service running on a computer. The service maintains a service object having a link to an access control entry. The access control entry contains an access right to perform an operation on an object type. The system further includes an access control module within the operating system. The access control module includes an access control interface and operates to grant or deny the access right to perform the operation on the object.

One shortcoming of prior art teachings is that they do not map access privileges to the data structures such as tables, views and other objects or constructs, belonging to a data warehouse, to the file permissions of the corresponding files as stored in a distributed file system. As a result, they do not utilize the access privileges of a data warehouse system in concert with a distributed file system in order to provide access control on files belonging to the data warehouse that are stored in the distributed file system.

Indeed in a Hadoop Distributed File System (HDFS), the data files corresponding to an Apache Hive database that are stored in HDFS are available for direct data access by an incoming data access request in HDFS. Such a prior art environment is depicted in FIG. 1, representing an unsecure distributed file system 10. In FIG. 1 the files corresponding to tables, objects and other constructs belonging to Hive data warehouse 12 are stored in HDFS 14. For example, for a Hive table 16 as depicted in FIG. 1 the corresponding file or files 18 are stored in HDFS.

A data access request 20 that comes through Hive data warehouse 12 for table 16, whether it be an Object Database Connectivity (ODBC) call, a Java Database Connectivity (JDBC) call, a Command Line Interface (CLI, for example Beeline) request, or any other Application Programming Interface (API) request, it will be restricted according to the permissions defined on table 16 in the metastore (not shown) belonging to Hive data warehouse 12. However, a data access request 22 directly into HDFS for file or files 18 corresponding to table 16 will be unrestricted and there may be the unintentional consequence of giving access to a potentially harmful access request which would be otherwise denied on table 16 in Hive data warehouse 14. Thus distributed file system 10 of Prior art comprising a Hive data warehouse and HDFS is unsecure because it cannot enforce access control on files in HDFS corresponding to Hive tables, objects and other constructs based on their permissions defined in Hive.

### OBJECTS OF THE INVENTION

In view of the shortcomings of the prior art, it is an object of the present invention to provide a secure distributed file system that utilizes the access privileges defined over tables, objects and other constructs of a data warehouse, and provide access control over corresponding files as stored in the distributed file system.

It is also an object of the invention to map the access privileges as defined in the data warehouse to the corresponding file permissions of the distributed file system in order to provide access control over files stored in the file system.

It is further an object of the invention to provide such access control with high performance and low overhead.

### SUMMARY OF THE INVENTION

The objects and advantages of the invention are given by a system and methods of securing a distributed file system. The invention teaches securing a distributed file system by providing access control to the data stored in the distributed file system based on mapping of access privileges from a data warehouse to the distributed file system. The main embodiments of the invention comprise a distributed file system, a data warehouse that has metadata comprising access privileges to the data contained in the data warehouse, and a translation or mapping of the access privileges from the metadata of the data warehouse to the file permissions of the distributed file system.

The access control provided by the invention can be further delivered by a security module implemented in the secure distributed file system. Such a security module may be a standalone software or service, or it can be a part of the distributed file system or the data warehouse. Indeed many such variations of the system implementation are possible as will be apparent to those skilled in the art.

In a highly preferred embodiment the distributed file system is a Hadoop Distributed File System (HDFS) and the data warehouse is a Hive data warehouse. While Hive has a permissions model for providing access control on its tables when access is initiated from Hive, an Open Database Connectivity (ODBC) interface, a Java Database Connectivity (JDBC) interface or the like, the data files and directories created and managed by Hive to represent its database constructs that reside as files in HDFS, are open for direct access via HDFS. In other words, the permissions model of HDFS has no knowledge of the permissions model of Hive. The highly preferred embodiment of the invention overcomes that problem by mapping the access privileges in the Hive metadata, stored in its ‘metastore’ to the file permissions of HDFS.

The invention is easily extended to other types of distributed and network file systems and data warehouses. Among the distributed file systems the choices include but are not limited to, a Network File System (NFS), Google File System (GFS), Ceph, Moose File System (MooseFS), Windows Distributed File System (DFS), BeeGFS (formerly known as Fraunhofer Parallel File System or FhGFS), Gluster File System (GlusterFS), Lustre, Ibrix or a variation of Apache HDFS. Of course, the system architecture and design of the implementation of invention will vary according to the choice of the distributed file system used, as will be apparent to those with average skill in the art.

Among data warehouses, the choices include but are not limited to Ab Initio Software, Amazon Redshift, AnalytiX DS, Apatar, Aster Data Systems, CloverETL, CodeFutures, Common Warehouse Metamodel, DATAllegro, Dataupia, FastExport, Graz Sweden AB, Greenplum, HMORN Virtual Data Warehouse, Holistic Data Management, HPCC, IBM InfoSphere DataStage, InfiniDB, Informatica, InterMine, Kalido, Microsoft Analysis Services, MonetDB, Netezza, Oracle Exadata, Oracle Warehouse Builder, ParAccel, Pervasive Software, SAND CDBMS, Scriptella, Sybase IQ, Talend, Teradata, Teradata FastLoad, Teradata Parallel Transporter, WhereScape or a variation of Apache Hive data warehouse. Of course, the system architecture and design of the implementation of the invention will vary according to the choice of the data warehouse used, as will be apparent to those with average skill in the art.

In another advantageous embodiment, the access control framework is implemented as a permissions checker module and a permissions service. In response to a data access request for a file or files stored in the distributed file system, the permissions checker module communicates with the permissions service to determine the permissions on the requested file or files. If the response from the permissions service is Allow, the request is granted access to the requested file or files, otherwise if the response is a Deny, the access is denied. It will be obvious to those with skill in the art that the Allow and Deny messages are placeholders that can be easily substituted with any other suitable responses for a given IT eco-system. Additionally, the lack of a response message can also be meaningfully interpreted in a given implementation. For example, if the permissions service does not return a response to the permissions checker module in a timely fashion, then also the requested access is denied.

A preferred embodiment further uses a custom data path monitor module that can be used to control access to any custom path configured in the distributed file system and apply user defined access privileges to that custom path in the file system. This further extends the access control capability taught by the invention to files and directories in the distributed file system above and beyond to those belonging to the data warehouse.

The methods of the invention teach the steps required to carry out the operations and working of the secure distributed file system. The invention teaches using a distributed file system, the security metadata of a data warehouse and then mapping the access privileges in the security metadata of the data warehouse to those defined in the distributed file system to provide an access control framework for the files stored in the distributed file system.

In the advantageous embodiment, the distributed file system is a Hadoop Distributed File System (HDFS), the data warehouse is an Apache Hive data warehouse, or a variation thereof, and the files in HDFS being protected by the access control framework offered by the invention are those belonging to the Hive data warehouse. Hive contains its metadata in a repository known as the Hive metastore. Among other pieces of metadata, the Hive metastore contains the access permissions or privileges to the Hive objects. The tables, objects and other constructs belonging to Hive are stored as files in HDFS.

The invention teaches the translation or mapping of these access privileges in the Hive metastore, to the file permissions defined in HDFS on the files belonging to Hive. Based on this translation or mapping, in response to a given data access request to the Hive files stored in the file system, HDFS either grants or denies access to that access request. The methods of the invention further teach the steps required to implement this access control mechanism. In a preferred embodiment, in response to a data request by a given user for a Hive file stored in HDFS, the permission check to the HDFS namenode is intercepted by the secure distributed file system. As a part of the intercept routine or process, the access privileges for the user requesting data as defined in Hive metastore are translated to the access privileges for that user as defined in HDFS, and subsequently the request is either allowed or denied access.

Specifically, for the user data access request to certain Hive file or files in HDFS, the translation or mapping mechanism determines the access privileges for that user to the corresponding Hive table object or objects as defined in the Hive metastore. If the user in question has authorization to access the corresponding table or objects as defined in the Hive metastore, then the data access request is allowed, otherwise denied.

The methods of the invention further teach the above access control framework to be implemented as a permissions checker module and a permissions service that operate in concert with the permissions checker module. Specifically, in response to a data access request to certain file or files stored in HDFS, the permissions checker module queries the permissions service to determine the access privileges for the user issuing the data access request on the corresponding Hive tables, objects and other constructs, as stored in the Hive metastore. Based on the response received by the permissions checker module from the permissions service, the permissions checker module either allows the data access request or denies it.

Permissions checker module and permissions service can be implemented in a variety of different ways as those familiar with computer system architecture and design will recognize. For example, the permissions service may be a standalone software or service, or it can be a part of another software component, such as the Hive data warehouse or even HDFS, without departing from the principles of the invention.

In the preferred embodiment, the permissions service decodes the HDFS inodes to corresponding Hive tables, objects and other constructs. Based on this decoding, the permissions service creates a translation or map of the access privileges of a given user on the Hive tables and objects as stored in the Hive metastore, and the file permissions on corresponding files in HDFS. It then subsequently uses this map to respond to permission queries from the permissions checker module in response to a user data access request for files residing in HDFS. A highly preferred embodiment keeps this mapping in memory or cache to reduce operational overhead and improve performance while responding to permission queries from the permissions checker module.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 (Prior Art) is a block diagram view of an unsecure Hadoop Distributed File System of the prior art.

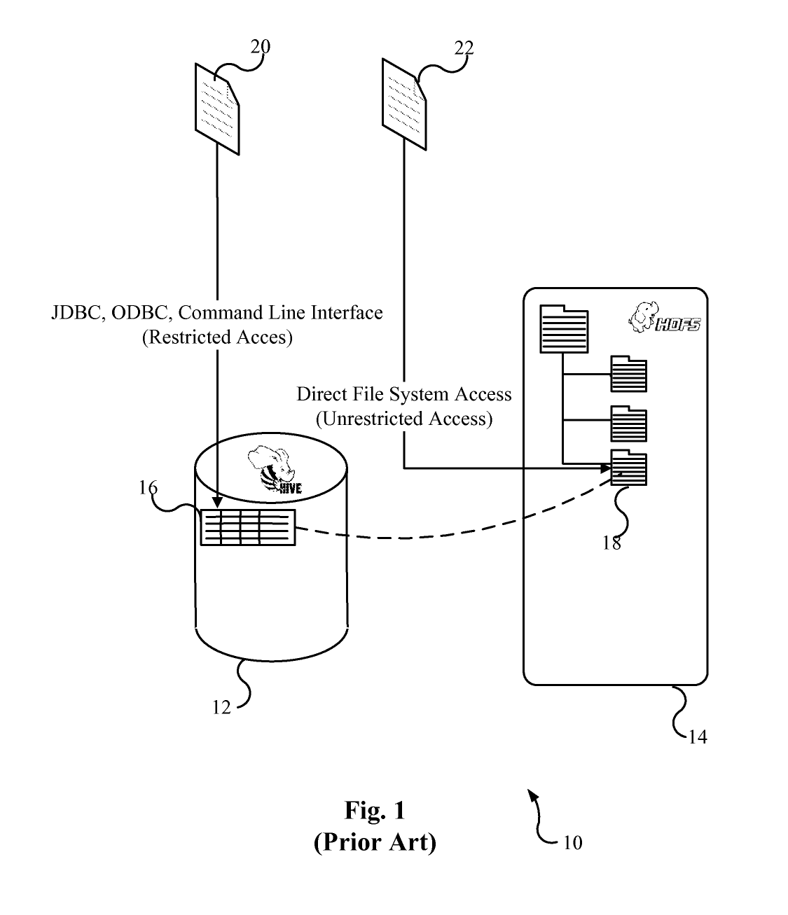

FIG. 2 is a block diagram view of the secure distributed file system according to the current invention.

FIG. 3 is a variation of the embodiment of FIG. 2 that uses a security module to provide access control.

FIG. 4 is depiction of the highly preferred embodiment of the current invention employing a Hadoop Distributed File System (HDFS) and a Hive data warehouse.

FIG. 5 shows a block diagram of a highly preferred embodiment and a variation of FIG. 4 that uses a permissions checker module and a permissions service.

FIG. 6 is a flowchart depiction of the steps required to carry out the operation of the permissions checker module.

FIG. 7 is a flowchart depiction of the steps required to carry out the operation of the permissions service.

FIG. 8 shows a portion of the embodiment of the invention that uses a custom data path monitor, showing HDFS and permissions checker module, with other components omitted for clarity.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

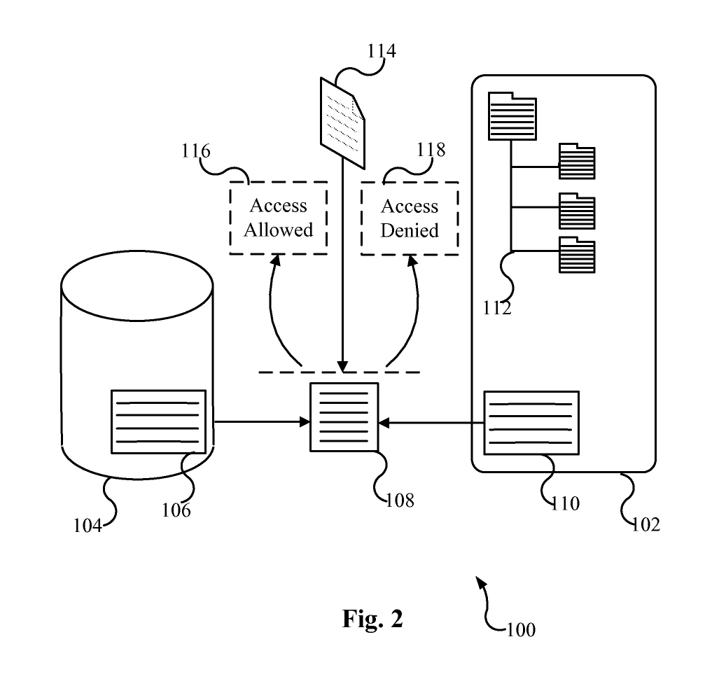

The present invention will be best understood by first reviewing the secure distributed file system 100 illustrated in FIG. 2. Secure distributed file system 100 comprises a distributed file system 102 and a data warehouse 104. Data warehouse 104 comprises metadata 106. Metadata 106 contains the access privileges to tables, objects and other constructs 120 belonging to data warehouse 104. Similarly, distributed file system 102 comprises file permissions 110 to files 112 stored in the file system 102.

According to the current invention, secure distributed file system 100 as represented in FIG. 2 provides access control on files 112 stored in distributed file system 102. It accomplishes that by mapping access privileges defined in metadata 106 on tables, objects and other constructs 120 of data warehouse 104 that correspond to files 112, to corresponding file permissions 110 defined in distributed file system 102 for files 112. Based on this mapping 108, secure distributed file system 100 of FIG. 2 provides access control to a data access request 114 that is requesting access to a file or files 112 stored in distributed file system 102. As determined by mapping 108, secure distributed file system 100 of FIG. 2 either allows access 116 to access request 114 for requested file or files 112, or denies access 118 to access request 114 for requested file or files 112 stored in distributed file system 102.

It will be familiar to those skilled in the art that data in a relational database or data warehouse is stored in tables containing rows and columns and commonly views that are defined on those tables. Similarly, the data belonging to data warehouse 104 in FIG. 2 is stored in tables, and other data objects. These tables, objects and other constructs 120 belonging to data warehouse 104 are ultimately stored as files 112 in distributed file system 102. Metadata 106 that contains access privileges on these tables, objects and other constructs 120 may be stored separately in the server software of data warehouse 104 or it may also be stored in distributed file system 102 without departing from the principles of the invention.

Secure distributed file system 100 of FIG. 2 establishes mapping 108 by examining the access privileges on tables, objects and other constructs 120 belonging to data warehouse 104, as defined in metadata 106, and file permissions 110 defined in distributed file system 102, on files 112 corresponding to the tables, objects and other constructs 120 belonging to data warehouse 104. For example, a table Persons defined in data warehouse 104 may exist as a file called Persons.dat in distributed file system 102. Thus for a given user Joe, mapping 108 translates the access privileges of Joe on the table Persons as defined in metadata 106 to the file permissions of Joe on file Persons.dat as defined in distributed file system 102.

Thus, in response to an incoming data access request 114 belonging to user Joe in distributed file system 102 requesting access to file Persons.dat, if Joe has access privileges to the table Persons, as defined in mapping 108 and ultimately as defined in metadata 106, then secure distributed file system 100 will allow Joe access to the file Persons.dat as shown by the dashed box 116. Otherwise if Joe does not have access privileges to the table Persons, then system 100 will deny Joe access to the file Persons.dat, as shown by the dashed box 118. The above description provides the teachings of the main embodiment of the invention and explains how secure distributed file system 100 provides access control to files 112 stored in the file system as claimed by the present invention.

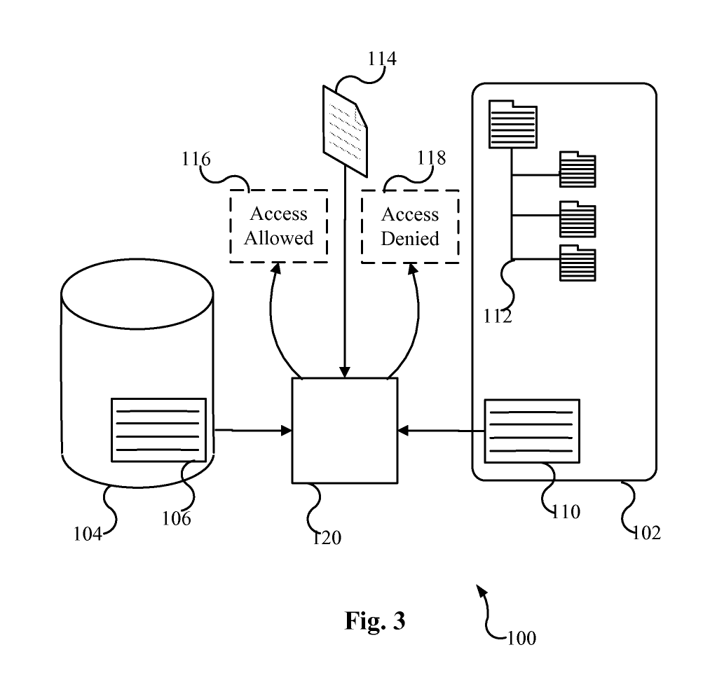

In a preferred embodiment of the invention, the access control taught above is provided by a security module 120 as illustrated in FIG. 3, where tables, objects and other constructs 120 belonging to data warehouse 104 have been omitted for clarity. Note that as depicted in FIG. 3, security module 120 is a standalone software or process that operably communicates with distributed file system 102 and data warehouse 104 to provide the access control on files 112 as taught above. However, as will be apparent to those skilled in the art of computer system design and architecture, security module 120 can be just as easily incorporated into and made part of distributed file system 102 without departing from the principles of the invention.

Similarly, security module 120 can also be a part of data warehouse 104 according to the principles of the current invention. It will also be apparent to those skilled in the art that mapping 108 of FIG. 2 which for clarity is omitted from FIG. 3, can easily be a part of security module 120 or stored separately in distributed file system 102, or data warehouse 104 without deviating from the principles of the invention.

The present invention places no restrictions on the specific type of the distributed file system or the data warehouse employed in the invention. As such, the choices for distributed file system 102 of FIG. 2 include but are not limited to Network File System (NFS), Google File System (GFS), Ceph, Moose File System (MooseFS), Windows Distributed File System (DFS), BeeGFS (formerly known as Fraunhofer Parallel File System or FhGFS), Gluster File System (GlusterFS), Lustre, Ibrix, Hadoop Distributed File System (HDFS) and a variation of Apache HDFS.

Similarly, the list of potential data warehouses that can be employed for data warehouse 104 of FIG. 2 is even longer. As such, data warehouse 104 of FIG. 2 can be any of, but not limited to, Ab Initio Software, Amazon Redshift, AnalytiX DS, Apatar, Aster Data Systems, CloverETL, CodeFutures, Common Warehouse Metamodel, DATAllegro, Dataupia, FastExport, Graz Sweden AB, Greenplum, HMORN Virtual Data Warehouse, Holistic Data Management, HPCC, IBM InfoSphere DataStage, InfiniDB, Informatica, InterMine, Kalido, Microsoft Analysis Services, MonetDB, Netezza, Oracle Exadata, Oracle Warehouse Builder, ParAccel, Pervasive Software, SAND CDBMS, Scriptella, Sybase IQ, Talend, Teradata, Teradata FastLoad, Teradata Parallel Transporter, WhereScape, Apache Hive, and a variation of Apache Hive data warehouse.

It will be apparent to those skilled in the art that the system architecture and design of the implementation of the invention will vary according to the type of distributed file system and data warehouse employed, without departing from the claims, principles and teachings of the current invention.

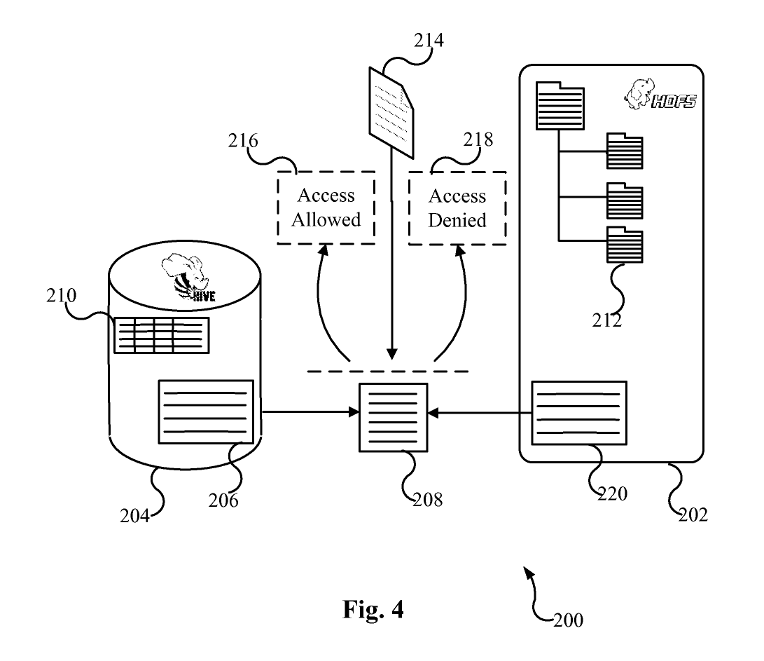

A highly preferred embodiment of the current invention employs HDFS as distributed file system 102 of FIG. 2 and Hive as data warehouse 104 of FIG. 2, to provide access control over files stored in HDFS. As such, special attention will be given to this embodiment in the following explanation. Such an embodiment is illustrated in FIG. 4 showing HDFS 202 and Hive 204 with their corresponding Apache logos. In this embodiment, metadata 206 is the Hive metastore.

Metastore 206 contains metadata related to Hive data warehouse 204. Among other types of metadata, metastore 206 also contains the access privileges on tables, files or other constructs used by Hive data warehouse 204. In such an embodiment, secure distributed file system of the current invention, which can be called as secure HDFS, is represented by label 200 in FIG. 4. Thus secure HDFS 200 of FIG. 4 provides access control over HDFS files 212. These files correspond to Hive tables, objects and other constructs, belonging to Hive data warehouse 204.

Secure HDFS 200 of FIG. 4 accomplishes that by first mapping access privileges over Hive tables and files as defined in metastore 206 belonging to Hive data warehouse 204, and the file permissions 220 on their corresponding files 212 in HDFS. Explained further, let us assume a table Persons as represented by 210 in Hive data warehouse 204 and its corresponding file or files 212 in HDFS 202. Those skilled in the art will understand that the data file belonging to Hive table Persons may be a text file in American Standard Code for Information Interchange (ASCII) or some other suitable format. Let us assume that file is called file1.txt and is represented by 212 in FIG. 4 and is stored in HDFS 202. A user Joe will have access privileges on table Persons 210 in Hive 204 with those access privileges defined in Hive metastore 206. Secure HDFS 200 of the present invention will maintain a map or mapping 208 of access privileges of users, including Joe, on table Persons 210 as defined in metastore 206 and their privileges on file file1.txt 212 as defined by file permissions 220 in HDFS 202.

If user Joe makes a data access request 214 as shown in FIG. 4 for file file1.txt 212, then secure HDFS 200 of the present invention will query mapping 208 as established above and accordingly respond to access request 214. Specifically, if user Joe has access privileges on Hive table Persons 210 according to mapping 208 in FIG. 4, then secure HDFS 200 will allow access to Joe's data access request 214, as represented by dashed box 216. On the other hand, if user Joe does not have access privileges on Hive table Persons 210 according to mapping 208, the system 200 will deny access to request 214, as represented by dashed box 218.

Those with average skill in the art will understand that there are several types of access privileges in a relational database, e.g. SELECT, DELETE, INSERT, UPDATE. Similarly, there are several types of file permissions ordinarily provided on files in a file system, e.g. read, write, execute, or a combination of those. Hive-HDFS mapping 208 as taught by the current invention will make the appropriate translation of privileges on Hive database tables, objects and other constructs, and the corresponding file permissions defined in HDFS. Using our example of data access request 214 by Joe above, if request 214 is a read request for file file1.txt 212, then secure HDFS 200 will look for SELECT privilege for Joe on Hive table Persons 210 in metstore 206 and respond to request 214 accordingly.

Similarly if Joe's request is to write on file file1.txt 212, then secure HDFS 200 will look for INSERT, UPDATE or DELETE privileges on Hive table Persons 210 for Joe in metastore 206, and respond to request 214 accordingly. Note the precise mapping of which relational database privileges map to exactly which file permissions in HDFS may vary in a given implementation of secure HDFS 200 without departing from the principles of the invention. Note also that data file for Hive table Persons may be more than one files, have a different file naming convention, and be a text or binary file(s) without departing from the principles of the invention.

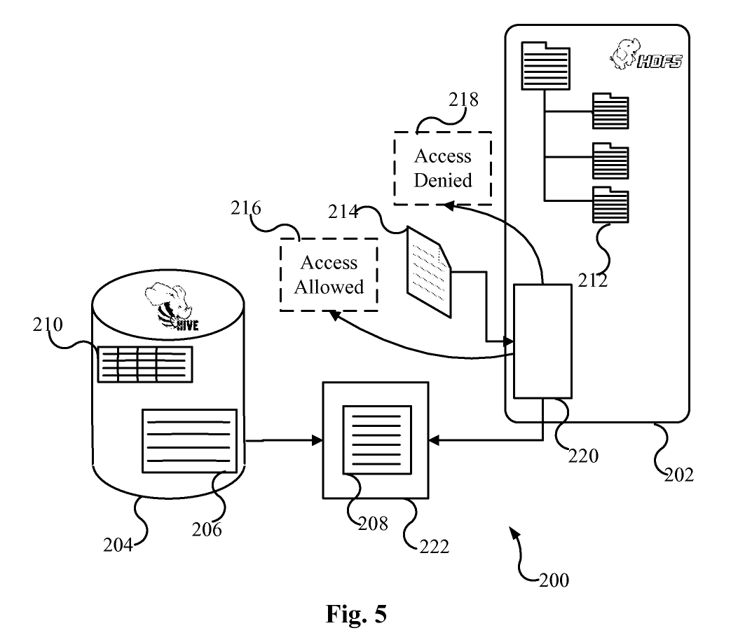

A highly preferred variation of the above embodiment is depicted in FIG. 5. In this embodiment, there is a permissions checker module 220 in Hadoop Distributed File System (HDFS). Permissions checker module 220 operably communicates with a permissions service 222 as depicted by the directed arrow. Permissions service 222 can be a separate software server, on the same or a different hardware, or be a part of another program within the scope of the invention.

Permissions service 222 maintains the Hive-HDFS permissions mapping 208, as taught above in detail. Mapping 208 can be internal or external to permissions service 222 within the scope of the invention. Request to access a file 212 in file system 202 is serviced by permissions checker module 208 in consultation with permissions service 222. Specifically, in response to data access request 214 of FIG. 5 permissions checker module 220 queries permissions service 222 to determine whether or not to grant access to request 214 on requested file or files 212.

Subsequently, based on Hive-HDFS permissions mapping 208, permissions service 222 responds to the above query from permissions checker module 220 by an Allow or Deny message, indicating to permissions checker module 220 whether to grant access to data access request 214 or to deny it. Subsequently, permissions checker module responds accordingly to data access request 214 by either granting requested access 216, or denying it 218. Those skilled in the art will recognize that the Allow or Deny message response from permissions service 222 to permissions checker module 220 are placeholders and can be easily substituted for any other appropriate responses in a given IT implementation. Similarly, the lack of a response from permissions service 222 to permissions checker module 220 may also be interpreted as a denial of access to request 214 by permissions checker module 220.

Those skilled in the art will understand the basic architecture behind Hadoop Distributed File System (HDFS). A good reference is the Apache Hadoop website (http://hadoop.apache.org/), or for a convenient pooled source of information, the reader is directed to the HDFS chapter of The Architecture of Open Source Applications by Robert Chansler (http://www.aosabook.org/en/hdfs.html), with the relevant content summarized in the below paragraph for completeness.

HDFS stores file system metadata and application data separately. It stores metadata via a process called namednode, which may or may not be on a dedicated server. Namenode keeps track of data blocks assigned to files and their respective location within HDFS. Application and user data are typically stored on other servers called datanodes. All servers are fully connected and communicate with each other using Transmission Control Protocol (TCP) based protocols. For redundancy and reliability, file content is replicated on multiple datanodes. Further, the HDFS namespace is a hierarchy of files and directories. Files and directories are represented on the namenode by inodes. Inodes contain file attributes like permissions, modification and access times, namespace and disk space quotas. The namenode maintains the namespace tree and the mapping of data blocks to datanode.

Further, readers skilled in the art will also recognize that the concept of inode (or Index Node) is not new to HDFS. For example, in the Linux file system, inodes are also used to store metadata entries about each file, directory or object. Each entry is 128 bytes in size and can include the following:
Inode number
Direct/indirect disk blocks
Number of blocks
File access, change and modification time
File deletion time
File size
File type
Group
Number of links
Owner
Permissions
Status flags

Based on above knowledge, now let us turn our attention to FIG. 5. Permissions checker module 220 may be a module that is dependent on the Hadoop distribution being used by secure distributed file system 200. The main Hadoop distributions at the time of this writing are Cloudera's CDH, Hortonworks' HDP, mapR, IBM Big Insights and Pivotal. However, the principles of the invention easily apply to any other Hadoop distribution of the present or in the future. In the preferred embodiment, permissions checker module 220 intercepts an HDFS namenode permission check. This check is performed by HDFS for determining file permissions in the namenode by examining the inode of the file to which access is being requested.

Thus, using the previous example of FIG. 5, in response to data access request 214 by Joe requesting access to HDFS file 212, permissions checker module intercepts the permissions check performed by HDFS on the namenode of the Hadoop cluster. Let us assume HDFS file file1.txt 212 to be the data file corresponding to table Persons 210 on Hive data warehouse 204. In the preferred embodiment of the current invention, rather than simply looking at the permissions on file file1.txt 212 for user Joe as defined in HDFS and as contained in the respective inode entry of the file on the namenode, permissions checker module 220, modifying the default behavior of HDFS, will in turn query permissions service 222 to determine the file permissions on file file1.txt 212.

Subsequently, permissions service 222 will decode inode entry for file file1.txt 212 to corresponding Hive table, in our example, Persons. Then, based on the privileges of user Joe on Hive table persons 210, permissions service 222 will establish mapping of privileges of user Joe to corresponding file file1.txt 212 in HDFS. Based on this mapping for access privileges of user Joe, permissions service 222 will respond to the permission query from permissions checker module 220 with an Allow or Deny response. Accordingly permissions checker module will respond to data access request 214 by either allowing the request 216 or denying it 218.

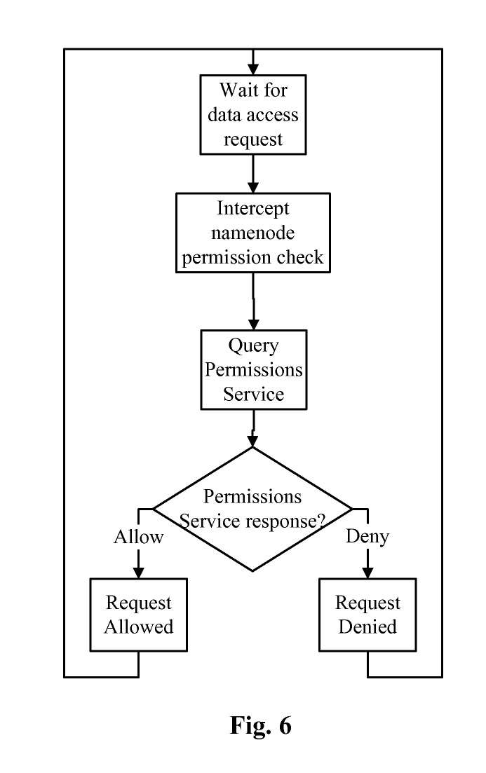

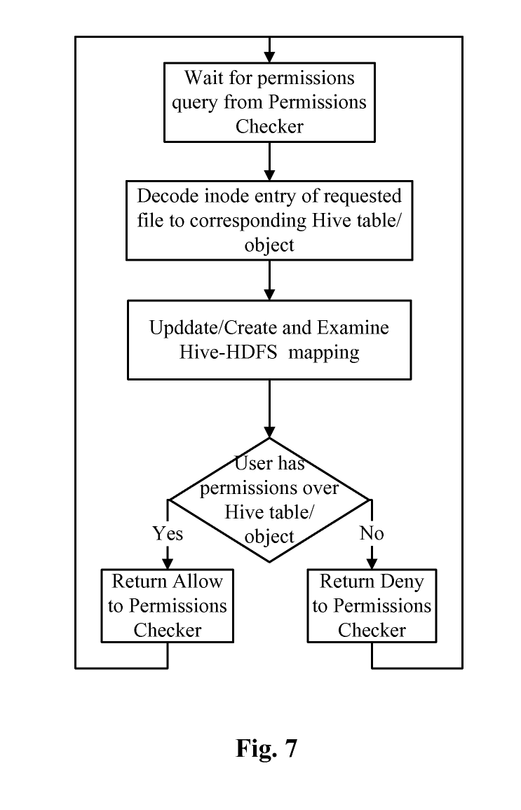

FIG. 6 and FIG. 7 illustrate in a flowchart form the operation of the above embodiment of the secure distributed file system of the present invention. Specifically, FIG. 6 outlines the steps carried out by the permissions checker module as taught above, and FIG. 7 outlines the steps carried out by the permissions service that operates in concert with the permissions checker module as previously explained.

It will be obvious to those with skill in the art that the Allow and Deny messages communicated by permissions service to the permissions checker module can be easily substituted with any other suitable responses for a given IT implementation. Additionally, the lack of a response message can also be meaningfully interpreted in a given implementation. For example, if the permissions service does not return a response to the permissions checker module in a timely fashion, then that can also interpreted as an access denied response by the permissions checker module.

As will also be apparent to those skilled in the art, it is entirely possible to place the HDFS inode decoding logic as taught above in the permissions checker module itself without departing from the principles of the invention. Similarly, it is possible to have Hive-HDFS mapping 208 of FIG. 5 be also contained in permissions checker module 220. Indeed, there are many such variations of the system design possible, where permissions mapping and decoding logic can be designed to be part of different system components and subsystems, within the scope of the current invention.

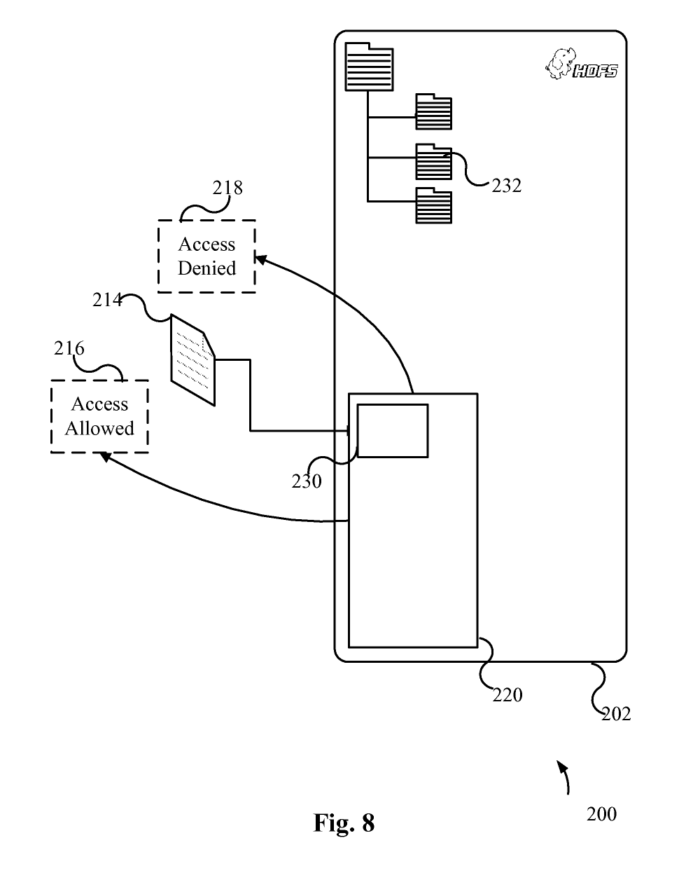

In addition to providing access control over HDFS files that correspond to a given Hive table, object or other constructs, secure distributed file system of current invention can also provide such access control over a custom directory path configured in the file system. Such an advantageous embodiment is depicted in FIG. 8 which shows HDFS 202 from FIG. 5, permissions checker module 220 and a custom data path monitor module 230. Note that other components of the distributed file system of FIG. 5 have been omitted from FIG. 8 for clarity.

In the above embodiment, system 200 will allow the configuration of a user defined custom directory path or paths in HDFS and allowable user-defined permissions on such path or paths as desired. One skilled in the art will understand that there are many ways in which such a configuration can be provided. For example, the custom path or paths, and corresponding permissions can be defined in a configuration file, input through a command line interface, or entered through a graphical user interface (GUI) form. Once the path or paths being monitored and the corresponding permissions are entered into the system, custom data path monitor 230 of FIG. 8 will continually monitor incoming user data access requests for configured path or paths.

If a request is for a file or files contained in a configured custom path or paths being monitored by custom data path monitor 230, this will trigger a different response from permissions checker module 220 than if the data request were for a file belonging to a Hive table or object as taught above. Specifically, in response to a data access request for a file residing in a custom data path or paths as configured above is received, permissions checker module will respond to the request according to the user-defined permissions for the custom path or paths configured in the system according to the above explanation.

Hence if request 214 in FIG. 8 by user Joe is for a file file2.txt 232 and file file2.txt 232 is in a custom path configured to be monitored as taught above, then custom data path monitor 230 of FIG. 8 will consult the user-defined permissions configured in the system on the custom path according to above explanation. If configured permissions allow user Joe to access file file2.txt 232, then permissions checker module 220 will allow access 216 to request 214, otherwise deny it 218.

As will be obvious to those skilled in the art that in the above embodiment if the data access request is for a file that neither corresponds to a Hive table or object, nor is contained in a custom path or paths being monitored, then the behavior of permissions checker module may be to provide the default response of HDFS to the data access request based on the permissions defined in the inode entry for the requested file or files in the namenode.

In a highly preferred embodiment, permissions service of FIG. 5 caches Hive-HDFS mapping 208 to improve its performance while responding to permission queries from permissions checker module 220. Further, from a performance perspective, using the the design of the secure distributed file system as taught above, since security module 120 of FIG. 3 and permissions checker module 220 of FIG. 5 only monitor access requests for files that correspond to the Hive tables, objects and other constructs, the overhead in providing the access control on these files is very low. Similarly, as custom data path monitor 230 of FIG. 8 only intervenes when access request is for file(s) in the custom path or paths as configured above, the performance overhead incurred by custom data path monitor 230 is low.

Those skilled in the art will find the term access control familiar. Though in the general sense, access control includes authentication, authorization, access approval and audit a narrower definition may include a subset of the above components. Hence persons familiar with the art will readily observe that secure distributed file system and its functionality as taught above may be embodied in many different ways without departing from the principles of the invention.

For example, security module 120 in FIG. 3 may also perform authentication of data access request 114 to ensure that the credentials of the request, if provided, are verified. Similarly, permissions checker module 220 or permissions service 222 of FIG. 4, FIG. 5 and FIG. 8 may also authenticate data access request 214 to verify the user credentials, provided the user credentials are provided as part of the request or in the request context. Similarly security module 120 of FIG. 3, permissions checker module 220 and permissions service of FIG. 4, FIG. 5 and FIG. 8 may also perform auditing of data access

Similarly, while the above teachings have provided a detailed explanation for embodiments of the invention pertaining to a Hadoop environment and its components, the claims and teachings of the invention are easily extended to other types of distributed file systems and data warehouses. As will be apparent to those skilled in the art, that the details of the implementation of the mapping, security module, permissions checker module and permissions service as taught above will vary according to the type of distributed file system and data warehouse employed, without departing from the claims, principles and teachings of the current invention.

Indeed, in view of the above teaching, a person skilled in the art will recognize that the apparatus and method of invention can be embodied in many different ways in addition to those described without departing from the principles of the invention. Therefore, the scope of the invention should be judged in view of the appended claims and their legal equivalents.

I claim:

1. A secure distributed file system comprising:
a) a data warehouse with associated metadata;
b) access privileges governing access to data in said data warehouse;
c) mapping(s) of said access privileges to file permissions defined in said distributed file system;
wherein access control on file(s) in said distributed file system is governed in accordance with said mapping(s).

2. The system of claim 1 wherein said distributed file system is a Hadoop Distributed File System (HDFS).

3. The system of claim 1 wherein said distributed file system is a network file system.

4. The system of claim 1 wherein said access control is enforced on those files stored in said distributed file system, that belong to said data warehouse.

5. The system of claim 1 wherein said access control is enforced by a security module.

6. The system of claim 5 wherein said security module is a component of said distributed file system.

7. The system of claim 5 wherein said security module is a component of said data warehouse.

8. The system of claim 1 further comprising a permissions checker module that, in response to a data access request to said file(s) stored in said distributed file system, allows or denies access to said request, based on permissions of said requested file(s) as determined by said permissions checker module.

9. The system of claim 8 wherein said permissions checker module is a component of said distributed file system.

10. The system of claim 8 wherein said permissions checker module operably communicates with a permissions service to determine said permissions.

11. The system of claim 10 wherein said permissions service communicates an Allow or Deny response to said permissions checker module based on said mapping(s).

12. The system of claim 8 wherein said permissions checker module further comprises a custom data path monitor for providing said access control over any configured path in said distributed file system.

13. The system of claim 1 wherein said data warehouse is an Apache Hive data warehouse.

14. The system of claim 13 wherein said access privileges are defined over tables, objects and other constructs belonging to said Hive data warehouse and are contained in its metastore.

15. The system of claim 1 wherein said distributed file system is selected from the group consisting of Network File System (NFS), Google File System (GFS), Ceph, Moose File System (MooseFS), Windows Distributed File System (DFS), BeeGFS (formerly known as Fraunhofer Parallel File System or FhGFS), Gluster File System (GlusterFS), Lustre, Ibrix and a variation of Apache Hadoop Distributed File System (HDFS).

16. The system of claim 1 wherein said data warehouse is selected from the group consisting of Ab Initio Software, Amazon Redshift, AnalytiX DS, Apatar, Aster Data Systems, CloverETL, CodeFutures, Common Warehouse Metamodel, DATAllegro, Dataupia, FastExport, Graz Sweden AB, Greenplum, HMORN Virtual Data Warehouse, Holistic Data Management, HPCC, IBM InfoSphere DataStage, InfiniDB, Informatica, InterMine, Kalido, Microsoft Analysis Services, MonetDB, Netezza, Oracle Exadata, Oracle Warehouse Builder, ParAccel, Pervasive Software, SAND CDBMS, Scriptella, Sybase IQ, Talend, Teradata, Teradata FastLoad, Teradata Parallel Transporter, WhereScape and a variation of Apache Hive data warehouse.

17. A method of enforcing access control in a distributed file system, comprising the steps of:
a) using permission metadata of a data warehouse;
b) mapping access privileges in said permission metadata to file permissions defined in said distributed file system;
wherein said access control to files in said distributed file system is governed in accordance with said mapping.

18. The method of claim 17 wherein said distributed file system is a Hadoop Distributed File System (HDFS).

19. The method of claim 18 wherein said data warehouse is an Apache Hive data warehouse and said permission metadata is contained in its metastore.

20. The method of claim 19 wherein said files are corresponding to tables, objects and other constructs belonging to said Hive data warehouse.

21. The method of claim 19 wherein said access control is provided by a permissions checker module that, in response to a user data access request to said files stored in said HDFS, allows or denies access to said files based on permissions determined by said permissions checker module.

22. The method of claim 21 wherein said permissions checker module operably communicates with a permissions service to determine said permissions.

23. The method of claim 22 wherein said permissions service decodes inodes of said HDFS to corresponding objects of said Hive data warehouse.

24. The method of claim 22 wherein said permissions service establishes said mapping based on access privileges of said user in said user data access request on Hive tables, objects and other constructs, as defined in said metastore, and corresponding said file permissions of said user on said files that correspond to said Hive tables, objects and other constructs.

25. The method of claim 22 wherein said permissions service caches said mapping in memory to improve performance.

26. The method of claim 21 wherein said permissions checker module provides said access control by intercepting namenode permission check in response to said user data access request.

27. The method of claim 21 wherein said permissions checker module operably communicates with a custom data path monitor for providing access control over a custom path configured in said distributed file system.
